(19) United States
(12) Patent Application Publication
(10) Pub. No.: US 2017/0241857 A1
(43) Pub. Date: Aug. 24, 2017

(54) METHOD OF ASSEMBLING AND TESTING A SIMULATED CIGARETTE

(71) Applicant: Kind Consumer Limited, London (GB)

(72) Inventors: Alex HEARN, London (GB); Khine Zaw NYEIN, Harrow, Middlesex (GB); David HACKETT, Kent (GB); Moira BOWDREY, Cambridge (GB)

(21) Appl. No.: 15/514,436

(22) PCT Filed: Sep. 25, 2015
(86) PCT No.: PCT/GB2015/052787

§ 371 Date: Mar. 24, 2017

(30) Foreign Application Priority Data
Sep. 26, 2014 (GB) 1417051.8

(51) Int. Cl. G01M 3/26; A24F 47/00

(52) U.S. Cl. CPC G01M 3/26; A24F 47/002

(57) ABSTRACT

A method of assembling and testing a simulated cigarette. Assembling the simulated cigarette to have an elongate main body containing a reservoir for an inhalable composition, a breath operated valve, and a refill valve. Testing the integrity of the reservoir requires applying a pressured gas to open the refill valve to pressurise the reservoir, measuring the pressure drop in the reservoir, and providing a pass indication if the pressure drop remains below a predetermined threshold. It also requires testing the breath operated valve by applying suction at an inhaling end, measuring the flow rate from the cigarette and providing a pass indication if the flow rate falls outside a predetermined limit.

The present invention relates to a method of assembling and testing a simulated cigarette.

The applicant has previously disclosed a simulated cigarette having an elongate main body containing a reservoir of inhalable composition and having an inhaling end, with a breath operated valve to allow selective dispensing from the reservoir as suction is applied to the inhaling end drawing air through an air flow path in the cigarette. A refill valve at the opposite end allows the reservoir to be refilled.

An example of such a cigarette is disclosed, for example, in WO 2011/107737. In order to make a high quality mass producible product which provides a reliable dosage, it is desirable to test the integrity of every cigarette prior to filling the reservoir. However, no test is available to do this. If it is to be successful as a mass production technique, it must be capable of being able to be carried out quickly and reliably.

According to the present invention there is provided a method of assembling and testing a simulated cigarette, the method comprising the steps of assembling a simulated cigarette to have an elongate main body containing a reservoir for inhalable composition and having an inhaling end at one end, a breath operated valve at the inhaling end to allow selective dispensing from the reservoir as suction is applied to the inhaling end drawing air through an air flow path in the cigarette to open the breath operated valve, and a refill valve at a refill end which is opposite to the inlet end to allow the reservoir to be refilled; testing the integrity of the reservoir by applying a pressured gas at the refill end at a predetermined pressure, opening the refill valve to pressurise the reservoir, measuring the pressure drop in the reservoir for a predetermined time, and providing a pass indication if the pressure drop remains below a predetermined threshold; and testing the breath operated valve by applying suction at the inhaling end at a predetermined threshold flow rate, measuring the flow rate from the cigarette and providing a pass indication if the flow rate falls outside a predetermined limit.

The invention therefore provides a simple test of the integrity of the cigarette which is suitable for testing individual cigarettes on a mass production basis.

The predetermined threshold flow rate for the breath operated valve may be a first flow rate at which the breath operated valve is designed to open and the measured flow rate providing a pass indication is one which indicates that the breath operated valve has opened.

Alternatively, or additionally to the first flow rate, the predetermined threshold flow rate for the breath operated valve may be a second flow rate less than the flow rate at which the breath operated valve is designed to open and the measured flow rate providing a pass indication is one which indicates that the pressure drop across the cigarette is within a predetermined range.

Applying a lower flow rate at the inhaling end allows checking of the flow rate through the air flow path. It also checks that the breath operated valve is not opening at an abnormally low flow rate.

Preferably, the predetermined threshold flow rate is applied at both the first flow rate and the second flow rate to perform both of the above-mentioned tests.

The simulated cigarette may be one which has a wick such as that disclosed in WO 2011/107737. Alternatively, it may have a reservoir which has no means of conveying the inhalable composition to the inhaling end. However, preferably, the assembly further comprises inserting a dip tube into the cigarette one end of which leads to the breath operated valve and the other end of which is open to the reservoir. The other end is preferably held at a fixed location within the reservoir.

Preferably, the refill valve is fixed to the main body in a manner which holds the dip tube in place.

An example of a method of assembling and testing a simulated cigarette will now be described with reference to the accompanying drawings, in which:

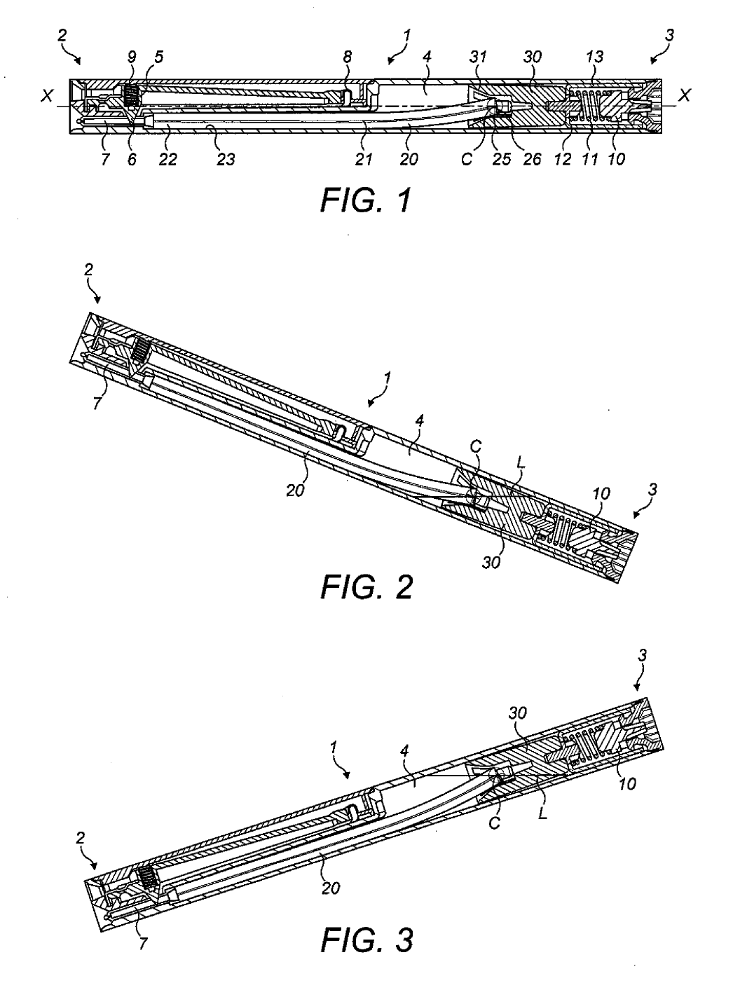

FIG. 1 is an axial cross section through the simulated cigarette;

FIG. 2 is a view similar to FIG. 1 in a “tip-down” configuration;

FIG. 3 is a view similar to FIGS. 1 and 2 in a “tip-up” configuration;

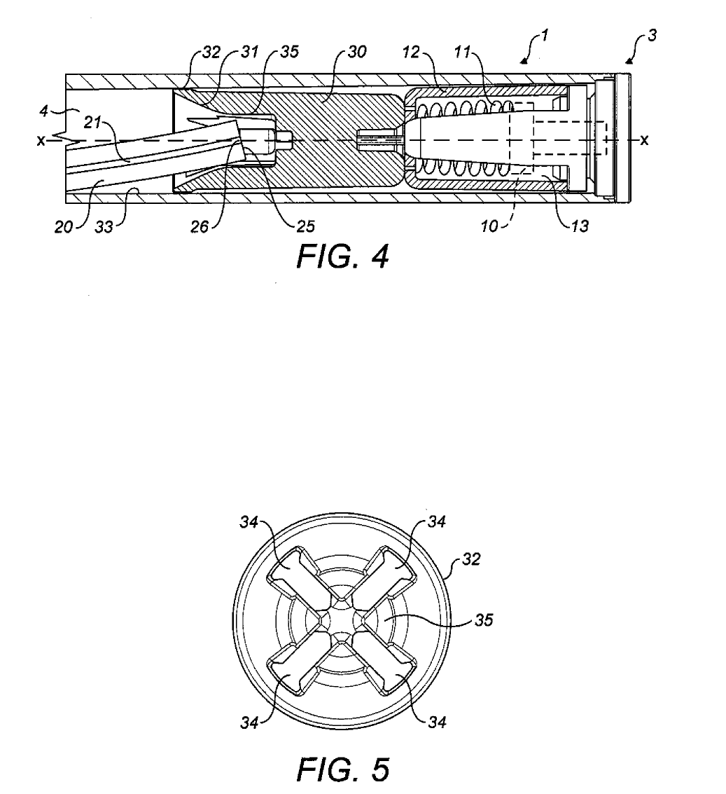

FIG. 4 is an axial cross section showing the right hand portion of FIG. 1 in greater detail; and

FIG. 5 is an end view of the tube support.

The basic arrangement of the simulated cigarette is as described in WO2011/107737. Thus, the simulated cigarette has a generally cylindrical shape and is approximately the size of a cigarette. It has a housing 1 with an outlet end 2 and a refill end 3 with a reservoir 4 occupying the majority of the internal space. At the outlet end 2 is an outlet valve 5 with a valve element 6 in the form of a tooth which pinches a resilient tube 7 in order to close the tube. The outlet valve 5 further comprises a vane which cooperates with a diaphragm 8 to open the valve element 6 against the action of a spring 9 when a user sucks on the outlet end 2 as described in WO2011/107737 and in greater detail in WO2014/033438.

At the opposite end of the reservoir 4 is the refill valve element 10 which is essentially a check valve which is openable against the action of a second spring 11. This is the subject of PCT/GB2014/050938. The second spring 11 and refill valve element 10 are retained in a cage 12 which has a number of openings 13 such that the space within the cage 13 forms part of the reservoir 4.

Also within the reservoir 4 is a flexible tube 20 with an internal bore 21. The bore 21 has an outlet 22 located adjacent to the end of the resilient tube 7 and can be placed against or is sealed to the wall 23 of the reservoir 4 in the vicinity of the outlet end so that the composition can only reach the outlet valve 5 via the bore 21. As is apparent from the drawings, it can be either the side wall or the end wall of the tube 20 that seal with the wall 23 of the reservoir 4 or the end of the tube 7, but it is preferably both. It will also be apparent from the drawings that the right hand side of the resilient tube 7 between the valve element 6 and the tube 20 is also a part of the reservoir.

At the inlet end 25 of the tube 20, the bore 21 has an inlet 26 which is supported by a support 30 so that the inlet end 25, and preferably the inlet 26 of the bore 21 is on the main axis X of the housing 1 as shown in FIG. 4.

The support 30 abuts against the valve cage 12 at the end of the support 30 closest to the refill end 3. The support 30 and valve cage 12 may be made as a single component. At the opposite end, the support 30 has a conical face 31 facing towards the outlet end 2. The outer diameter 32 of this end has a diameter corresponding to the internal diameter of the reservoir 4 at this point so that the support 30 is an interference fit within the reservoir 4. Four openings 34 as shown in FIG. 5 allow the liquid in the reservoir to freely pass the support 30 to gain access to the inlet 26.

To assemble the cigarette, the tube 20 is inserted into the reservoir 4 until it reaches the position shown in FIG. 1 in which the outlet 22 seals with the wall 23. The support 30 is then inserted from the same end and the conical face 31 picks up the inlet end 25 and guides it into a central region as shown in the drawings. The conical region 31 extends into a cylindrical region 35 which maintains the inlet end 25 of the tube 20 in the central region. The end of the tube may be tightly held in this position, or may be free to move a small amount which is immaterial to its ability to function. Even if it is tightly held, the openings 34 allow liquid in the reservoir to reach the inlet 26 of the bore 21.

It will be appreciated from the drawings and from the above explanation that the shape of the reservoir 4 is complex. The right hand portion has a generally cylindrical configuration occupying the majority of the diameter of the device while the left hand portion of the reservoir may just be the internal bore 21 of the tube, or there may be a portion of the reservoir on either side of this tube. Further, in the right hand portion, the volume of the reservoir is reduced by the inlet end portion of the tube 20, the support 30, the valve cage 12, the second spring 11 and the portion of the refill valve element 10 which is within the reservoir. Thus, while the volume of the reservoir 4 can be determined by measuring these components, it may be simpler to determine this experimentally.

The operation of the device will now be described with reference to FIGS. 1 to 3.

When a user sucks on the outlet end 2, the outlet valve 5 opens as previously described. Provided that the inlet 26 of the bore 21 is below the level L of the liquid in the reservoir, the liquid will travel along the bore 21 and will be atomised downstream of the outlet valve element 6 to create a plume for inhalation. FIGS. 1 to 3 show the centroid C of a body of liquid filling the reservoir 4. The inlet 26 of the bore 21 is in the vicinity of the centroid. In this specific example shown in FIG. 1, it is displaced by 1.3 mm from the centroid C towards the refill end 3. In the horizontal orientation shown in FIG. 1, all of the liquid above the level L which represents approximately 50% of the total liquid in the reservoir can be inhaled from the cigarette. When the cigarette is in the tip-down configuration shown in FIG. 2, as the inlet 26 is displaced from the centroid C as described above, slightly more liquid is available than it is in FIG. 1. Conversely, in the tip-up configuration, slightly less liquid is available for inhalation. In a different arrangement, the inlet 26 is at the centroid C, so that there is essentially no variation in dispensing between the three positions. The current preference is for a slight displacement of the inlet 26 towards the refill end from the centroid C as shown as this causes slightly more liquid to be dispensed in the more common tip-down orientation.

Once the cigarette reaches the liquid level position L shown in FIGS. 1 to 3 with the reservoir approximately half full, no further liquid can be inhaled and the cigarette is then refilled via the refill valve 10.

Once the simulated cigarette has been assembled, the following tests may be carried out.

### Airflow Test

An airflow test may be done using a Furness leak test unit. The reservoir of the device is pressurised to 6 bar and a flow rate is applied at the inhaling end of the cigarette at a rate of 4.0 litres/min (+/−10%) which should be sufficient to open the breath operated valve. The opening of the valve will trigger a flow out of the reservoir giving a sharp decrease in the reservoir pressure or an increase in the flow rate. This can be displayed to the user or the cigarette can simply be passed to the next stage of testing or processing.

### Leakage Test

The leakage test may be carried out using a Furness leak test unit. The refill end of the simulated cigarette is sealed with respect to the unit which pushes the refill valve open and the pressure of 6 bar is applied to the reservoir through the refill valve to pressurise the reservoir. After a short period allowing for temperature stabilisation, a pressure decay rate or an equivalent leak rate in cm³/min is measured over a period (for example 1 second). If there is any leak for example through or around the breath operated valve (in the above example through or around the tube 7), or from any other potential leakage path from the reservoir. This excludes the refill valve which remains open in this example. The subassembly comprising a refill valve in the example is tested separately prior to being inserted into the cigarette. The reservoir pressure will drop. The test unit indicates a pass or fail against the user's predefined acceptable leak rate, in this case, 1 cm³/min.

### Device Resistance Test

This is done using a Furness air flow unit which is adapted to receive and seal with the inhaling end of the simulated cigarette. The unit applies and generates an air flow rate of 1.05 litres/min (+/−10%) and the unit determines the pressure drop across the mouthpiece of the simulated cigarette. If the pressure drop across the mouthpiece is measured between 1 kPa and 4 kPa, the device airflow resistance is deemed to be within the required limits, indicating that the air flow path is not blocked. If there is some obstruction to the airflow paths, for example because a wrap has been placed on the cigarette in the wrong orientation, the pressure drop will be higher. On the other hand, if there is a problem with the breath operated valve such that it opens at too low a flow rate, the pressure drop will be lower. A visual indication that the cigarette has passed the test may be displayed and the actual pressure drop value may be displayed or recorded. Alternatively, the simulated cigarette may simply be passed on to the next stage of processing if it is deemed acceptable, in this case, to insert it into the pack or may be rejected if not.

These tests could be done in any order, but it would be preferable to complete the Airflow test first as it helps verify that the breath operated valve is able to reseal after being triggered.

1. A method of assembling and testing a simulated cigarette, the method comprising the steps of assembling a simulated cigarette to have an elongate main body containing a reservoir for inhalable composition and having an inhaling end at one end, a breath operated valve at the inhaling end to allow selective dispensing from the reservoir as suction is applied to the inhaling end drawing air through an air flow path in the cigarette to open the breath operated valve, and a refill valve at a refill end which is opposite to the inlet end to allow the reservoir to be refilled;
testing the integrity of the reservoir by applying a pressured gas at the refill end at a predetermined pressure, opening the refill valve and to pressurise the reservoir, measuring the pressure drop in the reservoir for a predetermined time, and providing a pass indication if the pressure drop remains below a predetermined threshold; and
testing the breath operated valve by applying suction at the inhaling end at a predetermined threshold flow rate, measuring the flow rate from the cigarette and providing a pass indication if the flow rate falls outside a predetermined limit.

2. A method according to claim 1, wherein the predetermined threshold flow rate for the breath operated valve is a first flow rate at which the breath operated valve is designed to open and the measured flow rate providing a pass indication is one which indicates that the breath operated valve has opened.

3. A method according to claim 1 wherein the predetermined threshold flow rate for the breath operated valve is alternatively or additionally a second flow rate less than the flow rate at which the breath operated valve is designed to open and the measured flow rate providing a pass indication is one which indicates that the pressure drop across the cigarette is within a predetermined range.

4. A method according to claim 1, wherein the test at the first flow rate is carried out after the test on the refill valve.

5. A method according to claim 1, wherein the assembly further comprises inserting a dip tube into the cigarette, one end of which leads to the breath operated valve and the other end of which is open to the reservoir.

6. A method according to claim 5, wherein the other end of the dip tube is held at a fixed location within the reservoir.

7. A method according to claim 5, wherein the refill valve is fixed to the main body in a manner which holds the dip tube in place.
